(19) United States
(12) Patent Application Publication
(10) Pub. No.: US 2026/0112714 A1
(43) Pub. Date: Apr. 23, 2026

(54) BATTERY MANAGEMENT DEVICE AND BATTERY MANAGEMENT SYSTEM

(71) Applicants: TOYOTA JIDOSHA KABUSHIKI KAISHA, Toyota-shi (JP); KABUSHIKI KAISHA TOYOTA CHUO KENKYUSHO, Nagakute-shi (JP)

(72) Inventors: Yoshiaki KIKUCHI, Toyota-shi (JP); Ryo MANO, Nisshin-shi (JP); Hiroki TASHIRO, Nisshin-shi (JP); Yuji NISHI, Nagoya-shi (JP); Keisuke ISHIKAWA, Nagakute-shi (JP)

(73) Assignees: TOYOTA JIDOSHA KABUSHIKI KAISHA, Toyota-shi (JP); KABUSHIKI KAISHA TOYOTA CHUO KENKYUSHO, Nagakute-shi (JP)

(21) Appl. No.: 19/322,120

(22) Filed: Sep. 8, 2025

(30) Foreign Application Priority Data
Oct. 17, 2024 (JP) 2024-181986

(51) Int. Cl. H01M 10/42; B60L 58/18; H01M 10/0525

(52) U.S. Cl. CPC H01M 10/425; B60L 58/18; H01M 10/0525; H01M 2010/4271; H01M 2220/20

(57) ABSTRACT

A battery management device according to the present disclosure includes: a high-frequency signal supply unit that supplies a high-frequency signal having 0.1 MHz or higher, to a lithium-ion secondary battery; an impedance detection unit that detects a value of a real part of an alternating-current impedance, from the lithium-ion secondary battery to which the high-frequency signal is supplied; a calculation unit that calculates a Li deposition amount in the lithium-ion secondary battery, from the detected value of the real part of the alternating-current impedance; and a control unit that decreases an allowable charging power for the lithium-ion secondary battery as the calculated Li deposition amount is larger.

### CROSS-REFERENCE TO RELATED APPLICATION

This application claims priority to Japanese Patent Application No. 2024-181986 filed on Oct. 17, 2024. The disclosure of the above-identified application, including the specification, drawings, and claims, is incorporated by reference herein in its entirety.

### BACKGROUND

### 1. Technical Field

The present disclosure relates to a battery management device and a battery management system.

### 2. Description of Related Art

For preventing the deterioration of the performance of a lithium-ion secondary battery, it is desired to restrain the deposition (referred to as Li deposition, hereinafter) of lithium (Li) metal in the lithium-ion secondary battery. However, a technique for detecting the Li deposition in the lithium-ion secondary battery in a non-destructive manner has not been known.

In response, as disclosed in Japanese Unexamined Patent Application Publication No. 2022-108602 (JP 2022-108602 A), the inventors have developed a technique of detecting the real part of the alternating-current impedance of the lithium-ion secondary battery using a high-frequency signal and calculating the Li deposition amount in the lithium-ion secondary battery based on the difference in the real part of the alternating-current impedance between the current value and the initial value.

### SUMMARY

The Li deposition progresses as the charging power is higher, and therefore, from the standpoint of the restraint of the Li deposition, an allowable charging power is set for each product kind of the lithium-ion secondary battery. As for the progress rate of the Li deposition in the lithium-ion secondary battery, there is a variation (for example, a standard deviation σ) depending on an individual product, even in the same product kind. In conventional lithium-ion secondary batteries, for example, in products included in a range of ±6σ, the allowable charging power for each product kind is set (fixed) to an excessively low value such that the Li deposition does not progress, and therefore, there is a problem in that the charging time is long.

The present disclosure has been made in view of the above circumstance, and has an object to provide a battery management device and a battery management system that make it possible to realize an efficient charging of the lithium-ion secondary battery.

A battery management device according to the present disclosure includes: a high-frequency signal supply unit that supplies a high-frequency signal having 0.1 MHz or higher, to a lithium-ion secondary battery; an impedance detection unit that detects a value of a real part of an alternating-current impedance, from the lithium-ion secondary battery to which the high-frequency signal is supplied; a calculation unit that calculates a Li deposition amount in the lithium-ion secondary battery, from the detected value of the real part of the alternating-current impedance; and a control unit that decreases an allowable charging power for the lithium-ion secondary battery as the calculated Li deposition amount is larger. The battery management device according to the present disclosure calculates the Li deposition amount in the lithium-ion secondary battery, from the value of the real part of the alternating-current impedance that is detected from the lithium-ion secondary battery to which the high-frequency signal is supplied, and performs a feedback control of the allowable charging power for the lithium-ion secondary battery, based on the calculated result. Thereby, the battery management device according to the present disclosure can set the allowable charging power for the lithium-ion secondary battery to an appropriate value depending on the Li deposition amount, instead of the setting to an excessively low value, and therefore, makes it possible to realize an efficient charging of the lithium-ion secondary battery.

With the present disclosure, it is possible to provide a battery management device and a battery management system that make it possible to realize an efficient charging of the lithium-ion secondary battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an exemplary configuration of a battery management system according to Embodiment 1;

FIG. 2 is a diagram showing the relation between the SOH of a secondary battery and a change amount of a real part Z of an alternating-current impedance when a high-frequency signal having 1 MHz is supplied to the secondary battery;

FIG. 3 is a diagram showing the relation between a frequency of an alternating-current signal that is supplied to the secondary battery and the real part of the alternating-current impedance that is detected from the secondary battery;

FIG. 4 is a diagram showing the relation between the frequency of an alternating-current signal that is supplied to the secondary battery and the real part of the alternating-current impedance that is detected from the secondary battery;

FIG. 5 is a flowchart showing an operation of a battery management device according to Embodiment 1; and

FIG. 6 is a block diagram showing an exemplary configuration of a battery management system according to Embodiment 2.

### DETAILED DESCRIPTION OF EMBODIMENTS

Specific embodiments to which the present disclosure is applied will be described below in detail with reference to the drawings. However, the present disclosure is not limited to the following embodiments. In addition, the following description and the drawings are simplified as appropriate to clarify the description.

### Embodiment 1

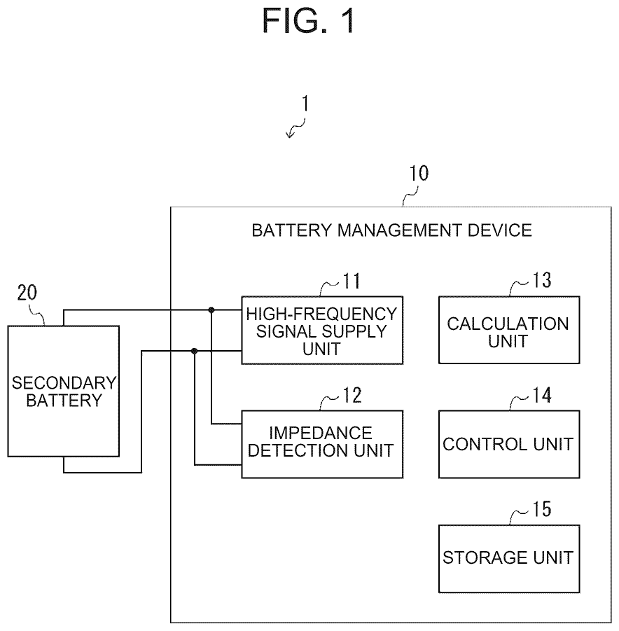

FIG. 1 is a block diagram showing an exemplary configuration of a battery management system according to Embodiment 1. As shown in FIG. 1, a battery management system 1 includes a battery management device 10 and a secondary battery 20 that is managed by the battery management device 10.

The secondary battery 20 is a lithium-ion secondary battery, and is constituted by a cell stack in which a plurality of battery cells is stacked, and a case that houses the cell stack.

Each battery cell includes a positive electrode, a negative electrode, and an ion conductive medium that is provided between the positive electrode and the negative electrode and that conducts carrier ions. A separator may be further provided between the positive electrode and the negative electrode. For the separator, resin such as polyethylene and polypropylene is used.

For a positive electrode active material, for example, a sulfide containing a transition metal element, or an oxide containing lithium and a transition metal element is used. Specifically, for the positive electrode active material, a lithium-manganese composite oxide having a basic composition formula of Li₍₁₋ₓ₎MnO2 (0<x<1), Li₍₁₋ₓ₎Mn₂O₄, or the like, a lithium-cobalt composite oxide having a basic composition formula of Li₍₁₋ₓ₎CoO₂ or the like, a lithium-nickel composite oxide having a basic composition formula of Li₍₁₋ₓ₎NiO₂ or the like, a lithium-nickel-cobalt-manganese composite oxide having a basic composition formula of Li₍₁₋ₓ₎NiₐCo_{b}Mn_{c}O₂ (a+b+c=1) or the like, or others is used. For the positive electrode active material, a substance in which another element is included in the above basic composition formula may be used. For a current collector of the positive electrode, for example, aluminum (Al) is used.

For a negative electrode active material, for example, a composite oxide containing lithium, or a carbon material is used. Specifically, for the negative electrode active material, an inorganic compound such as lithium, a lithium alloy, and a tin compound, a carbon material capable of storing and releasing lithium ions, a composite oxide containing a plurality of elements, a conductive polymer, or others is used. As the carbon material that is used for the negative electrode active material, there are coke, glassy carbon, graphite, non-graphitizable carbon, pyrolytic carbon, carbon fiber, and the like, and graphite such as artificial graphite and natural graphite is preferable. Further, as the composite oxide that is used for the negative electrode active material, there are a lithium-titanium composite oxide, a lithium-vanadium composite oxide, and the like. For a current collector of the negative electrode, for example, copper (Cu) is used.

The ion conductive medium is used as an electrolytic solution, by dissolving a supporting salt, for example. For the supporting salt, for example, a lithium salt such as LiPF₆ and LiBF₄ is used. For a solvent of the electrolytic solution, for example, carbonates, esters, ethers, nitriles, furans, sulfolanes, dioxolanes, or mixtures of some of them are used. As the carbonates, there are cyclic carbonates such as ethylene carbonate, propylene carbonate, vinylene carbonate, butylene carbonate, and chloroethylene carbonate, and chain carbonates such as dimethyl carbonate, ethyl methyl carbonate, diethyl carbonate, ethyl-n-butyl carbonate, methyl-t-butyl carbonate, di-i-propyl carbonate, and t-butyl-i-propyl carbonate. Alternatively, for the ion conductive medium, a solid ion-conducting polymer, an inorganic solid electrolyte, a mixed material of an organic polymer electrolyte and an inorganic solid electrolyte, inorganic solid powders bound by an organic binder, or the like may be used.

The battery management device 10 performs a charging management for the secondary battery 20 that is a management object. For example, the battery management device 10 detects a Li deposition amount in the secondary battery 20, in a non-destructive manner, and performs a feedback control of an allowable charging power (an upper limit value of the charging power) Pa for the secondary battery 20, based on the detection result.

The battery management device 10 includes a high-frequency signal supply unit 11, an impedance detection unit 12, a calculation unit 13, a control unit 14, and a storage unit 15.

The high-frequency signal supply unit 11 supplies a high-frequency signal to the secondary battery 20. The impedance detection unit 12 detects a value of a real part Z of an alternating-current impedance, from the secondary battery 20 to which the high-frequency signal is supplied.

In the secondary battery 20, by the repeat of charging, Li metal is deposited on an electrode surface of each battery cell. The Li deposition progresses as the charging power is increased for increasing the charging speed, and deteriorates the State-Of-Health (SOH) of the secondary battery 20. The SOH of the secondary battery 20 is the ratio of the current capacity of the secondary battery 20 when the initial capacity is 100%. Accordingly, for the secondary battery 20, it is desirable to set a highest possible allowable charging power Pa that allows an efficient charging in a shortest possible charging time while restraining the Li deposition.

In the case where an alternating-current signal (high-frequency signal) having such a high frequency that the diffusion, reaction, and movement of lithium ions cannot be followed in each battery cell of the secondary battery 20 is supplied to the secondary battery 20, electric current for the high-frequency signal flows along edges of electric conductors of the each battery cell, due to a skin effect. In other words, the electric current for the high-frequency signal flows on an electrode surface of each battery cell where Li is easily deposited, due to the skin effect. Further, also in the case where the Li metal is electrically disconnected from the negative electrode and becomes a float state after the Li deposition, electric current flows on the Li metal due to inductive connection and electric field connection. Accordingly, for example, as the Li deposition amount is smaller, the electric conductivity of the electrode surface of each battery cell is lower, and therefore, the value of the real part Z of the alternating-current impedance is larger. As the Li deposition amount is larger, the electric conductivity of the electrode surface of each battery cell is higher, and therefore, the value of the real part Z of the alternating-current impedance is smaller. A large amount of electric current concentrates on the Li metal having high electric conductivity, and therefore, around a Li deposition region, magnetic field is changed, so that eddy current is generated. The eddy current causes loss at a current collecting foil and an electric conductive portion of the electrode, but reduces the whole loss of the battery. Consequently, as the Li deposition amount is larger, the change in magnetic field is larger, and accordingly, the eddy current is higher, so that the value of the real part Z is smaller. Therefore, the Li deposition amount in the secondary battery 20 can be calculated from the value of the real part Z of the alternating-current impedance that is detected from the secondary battery 20 to which the high-frequency signal is supplied. When the Li deposition amount is found, the SOH of the secondary battery 20 can also be estimated.

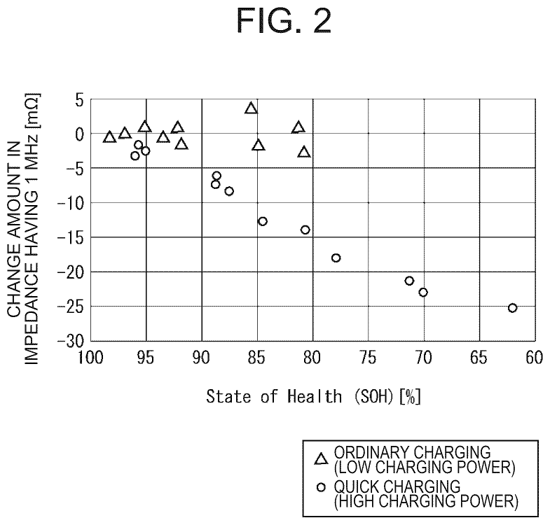

FIG. 2 is a diagram showing the relation between the SOH of the secondary battery 20 and the change amount (the difference between the detection value and the initial value) of the real part Z of the alternating-current impedance when a high-frequency signal having 1 MHz is supplied to the secondary battery 20. As shown by triangle marks in FIG. 2, in the case of an ordinary charging in which the charging power is low, even when the charging is repeated, the Li deposition amount is small, and therefore, even when the deterioration of the SOH progresses due to other causes, the change amount of the real part Z of the alternating-current impedance remains small (that is, the detection value of the real part Z of the alternating-current impedance is maintained at high values). On the other hand, as shown by circle marks in FIG. 2, in the case of a quick charging in which the charging power is high, when the charging is repeated, the Li deposition amount becomes large, and accordingly, the deterioration of the SOH progresses, so that the change amount of the real part Z of the alternating-current impedance is large (that is, the detection value of the real part Z of the alternating-current impedance is low). In the case where the battery deteriorates mainly due to the Li deposition, which is one of causes of the battery deterioration, the Li deposition amount can be derived from the SOH. Alternatively, the SOH can be derived from the Li deposition amount.

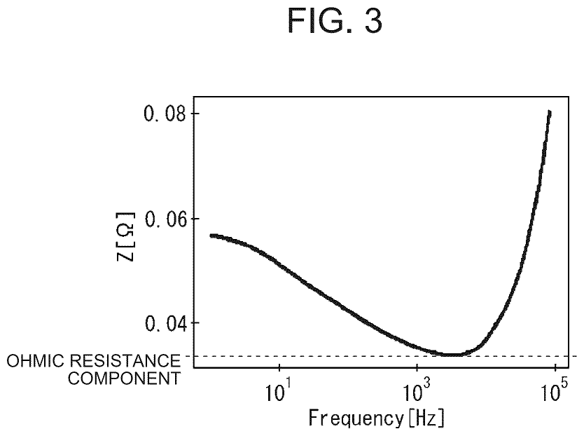

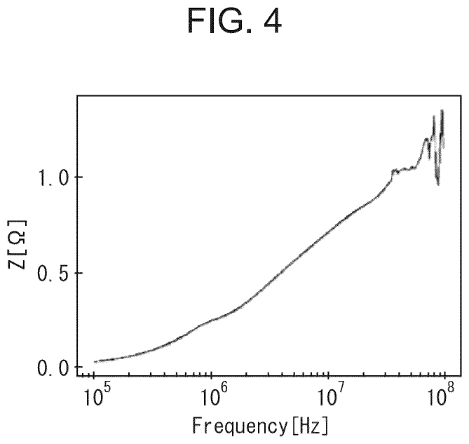

Each of FIG. 3 and FIG. 4 is a diagram showing the relation between a frequency of the alternating-current signal that is supplied to the secondary battery 20 and the real part of the alternating-current impedance that is detected from the secondary battery 20. FIG. 3 shows the value of the real part Z of the alternating-current impedance when alternating-current signals having 1 kHz to 100 kHz are supplied to the secondary battery 20. FIG. 4 shows the value of the real part Z of the alternating-current impedance when alternating-current signals having 100 kHz to 100 MHz are supplied to the secondary battery 20.

As shown in FIG. 3, in the case where the alternating-current signal having about 1 kHz is supplied to the secondary battery 20, the value of the real part Z of the alternating-current impedance becomes the minimum value. An impedance component in this case is an ohmic resistance component. Further, as shown in FIG. 3 and FIG. 4, as the frequency of the alternating-current signal that is supplied to the secondary battery 20 is higher, the flow of electric current concentrates on the electrode surface of each cell, due to the skin effect, and therefore, the value of the rear part Z of the alternating-current impedance is larger.

Hence, the high-frequency signal supply unit 11 supplies, to the secondary battery 20, an alternating-current signal (that is, a high-frequency signal) having a high frequency allowing the detection of the value of the real part Z of the alternating-current impedance that is sufficiently higher than the ohmic resistance component. For example, the high-frequency signal supply unit 11 supplies a high-frequency signal having 0.1 MHz or higher, to the secondary battery 20. Alternatively, the high-frequency signal supply unit 11 supplies, to the secondary battery 20, a high-frequency signal having such a frequency that the detected value of the real part Z of the alternating-current impedance, due to the skin effect, is 10 times or more of the value of the real part Z of an alternating-current impedance that is detected when an alternating-current signal having 1 kHz is supplied to the secondary battery 20. In examples in FIG. 3 and FIG. 4, the high-frequency signal supply unit 11 supplies a high-frequency signal having 0.5 MHz or higher, to the secondary battery 20. Thereby, the electric current for the high-frequency signal flows on the electrode surface (Li deposition region) of each battery cell of the secondary battery 20, due to the skin effect. Thereby, the impedance detection unit 12 can detect the real part Z of the alternating-current impedance corresponding to the Li deposition amount.

The calculation unit 13 calculates the Li deposition amount in the secondary battery 20, from the value of the real part Z of the alternating-current impedance that is detected by the impedance detection unit 12. More specifically, the calculation unit 13 calculates the Li deposition amount in the secondary battery 20, based on the difference between the current value of the real part Z of the alternating-current impedance that is detected by the impedance detection unit 12 and the initial value of the real part Z of the alternating-current impedance of the secondary battery 20. Information about the initial value of the real part Z of the alternating-current impedance of the secondary battery 20 that is the management object is stored in the storage unit 15, for example.

For example, the calculation unit 13 calculates the Li deposition amount such that the value of the Li deposition amount is smaller as the detected value of the real part Z of the alternating-current impedance is larger and such that the value of the Li deposition amount is larger as the detected value of the real part Z of the alternating-current impedance is smaller.

The storage unit 15 may store information about the initial value of the real part Z of the alternating-current impedance of the secondary battery for each product kind. Further, the storage unit 15 may store map information indicating the relation between the difference (change amount) between the current value (detection value) and the initial value in the real part Z of the alternating-current impedance of the secondary battery for each product kind and the Li deposition amount. The map information is information that is previously obtained by experiments, for example, and may be updated by information detected from the secondary battery 20 that is the management object, when appropriate. In this case, the calculation unit 13 extracts the Li deposition amount corresponding to the value of the real part Z of the alternating-current impedance that is detected by the impedance detection unit 12, from the map information stored in the storage unit 15.

The control unit 14 controls an allowable charging power Pa for the secondary battery 20, based on the Li deposition amount calculated by the calculation unit 13. For example, in the case where the calculated Li deposition amount is small, the progress of the Li deposition is restrained, and therefore, the control unit 14 performs such a control that the allowable charging power Pa is maintained at the current value or is increased. As the calculated Li deposition amount is larger, the progress of the Li deposition needs to be restrained, and therefore, the control unit 14 performs such a control that the allowable charging power Pa is decreased. For example, the control unit 14 may switch the allowable charging power Pa in stages, from 100% as the initial value to 95%, 90%, or others, depending on the calculated Li deposition amount.

Thereby, the battery management device 10 according to the present disclosure can set, for the secondary battery 20, a highest possible allowable charging power Pa that allows an efficient charging in a shortest possible charging time while restraining the Li deposition. That is, the battery management device 10 according to the present disclosure can set the allowable charging power Pa for the secondary battery 20 to an appropriate value depending on the Li deposition amount, instead of the setting to an excessively low value, and therefore, makes it possible to realize an efficient charging of the secondary battery 20.

### Operation of Battery Management Device 10

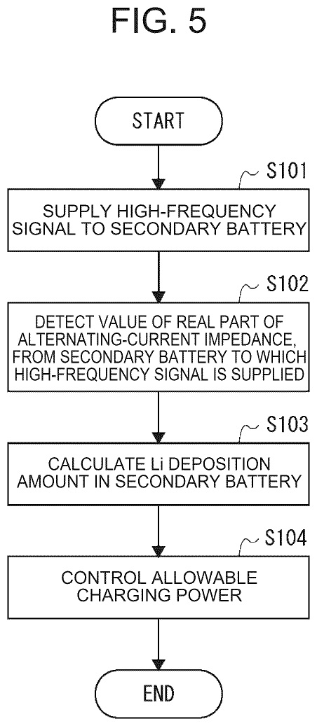

Subsequently, the operation of the battery management device 10 will be described with use of FIG. 5. FIG. 5 is a flowchart showing the operation of the battery management device 10.

First, the battery management device 10 supplies, to the secondary battery 20, an alternating-current signal (high-frequency signal) having such a high frequency that the diffusion, reaction, and movement of lithium ions cannot be followed in each battery cell (step S101). For example, the battery management device 10 supplies a high-frequency signal having 0.1 MHz or higher, to the secondary battery 20. Then, the battery management device 10 detects the value of the real part Z of the alternating-current impedance, from the secondary battery 20 to which the high-frequency signal is supplied (step S102).

Thereafter, the battery management device 10 calculates the Li deposition amount in the secondary battery 20, from the detected value of the real part Z of the alternating-current impedance (step S103). For example, the battery management device 10 extracts the Li deposition amount corresponding to the detected value of the real part Z of the alternating-current impedance, from the map information stored in the storage unit 15. Basically, the battery management device 10 calculates the Li deposition amount such that the value of the Li deposition amount is smaller as the detected value of the real part Z of the alternating-current impedance is larger and such that the value of the Li deposition amount is larger as the detected value of the real part Z of the alternating-current impedance is smaller.

Thereafter, the battery management device 10 controls the allowable charging power Pa for the secondary battery 20 based on the calculated Li deposition amount (step S104). For example, in the case where the calculated Li deposition amount is small, the progress of the Li deposition is restrained, and therefore, the battery management device 10 performs such a control that the allowable charging power Pa is maintained at the current value or is increased. As the calculated Li deposition amount is larger, the progress of the Li deposition needs to be restrained, and therefore, the battery management device 10 performs such a control that the allowable charging power Pa is decreased.

In this way, the battery management device 10 according to the present disclosure can set, for the secondary battery 20, a highest possible allowable charging power Pa that allows an efficient charging in a shortest possible charging time while restraining the Li deposition. That is, the battery management device 10 according to the present disclosure can set the allowable charging power Pa for the secondary battery 20 to an appropriate value depending on the Li deposition amount, instead of the setting to an excessively low value, and therefore, makes it possible to realize an efficient charging of the secondary battery 20.

An example in which the impedance detection unit 12, at an arbitrary timing, detects the value of the real part Z of the alternating-current impedance from the secondary battery 20 and the calculation unit 13 calculates the Li deposition amount in the secondary battery 20 based on the value of the real part Z of the alternating-current impedance that is detected at the arbitrary timing has been described, but the present disclosure is not limited to this.

For example, the impedance detection unit 12 may detect the value of the real part Z of the alternating-current impedance from the secondary battery 20 periodically at a measurement interval T1 that is designated by the control unit 14 or the like, and the calculation unit 13 may detect the change amount of the Li deposition during the measurement interval T1, based on the value of the real part Z of the alternating-current impedance that is detected periodically at the measurement interval T1. In this case, the control unit 14 performs such a control that the allowable charging power Pa for the secondary battery 20 is decreased as the increase amount of the Li deposition during the measurement interval T1 is larger. The control unit 14 may be configured to be capable of altering the measurement interval T1 to an arbitrary length. For example, the control unit 14 shortens the measurement interval T1 in an environment in which the Li deposition is easy, as exemplified by an environment in which the quick charging is performed, and lengthens the measurement interval T1 in an environment in which the Li deposition is hard, as exemplified by an environment in which the charging is performed by an electric power sufficiently lower than the allowable charging power.

Further, when the Li deposition amount in the secondary battery 20 reaches a first predetermined amount, the control unit 14 may dissolve the deposited lithium by mandatorily discharging the secondary battery 20. In this case, for example, the control unit 14 may maintain the allowable charging power Pa at the current value, when the Li deposition amount in the secondary battery 20 after the deposited lithium is dissolved is smaller than or equal to a second predetermined amount that is smaller than the first predetermined amount, and may perform such a control that the allowable charging power Pa is decreased, when the deposition amount is larger than the second predetermined amount.

Furthermore, in the case where the secondary battery 20 is mounted on a hybrid vehicle such as a hybrid electric vehicle (HEV) and a plug-in hybrid electric vehicle (PHEV) and where the control unit 14 dissolves the deposited lithium by mandatorily discharging the secondary battery 20, the control unit 14 may switch the hybrid vehicle from the drive with the secondary battery 20 to the drive with gasoline.

### Embodiment 2

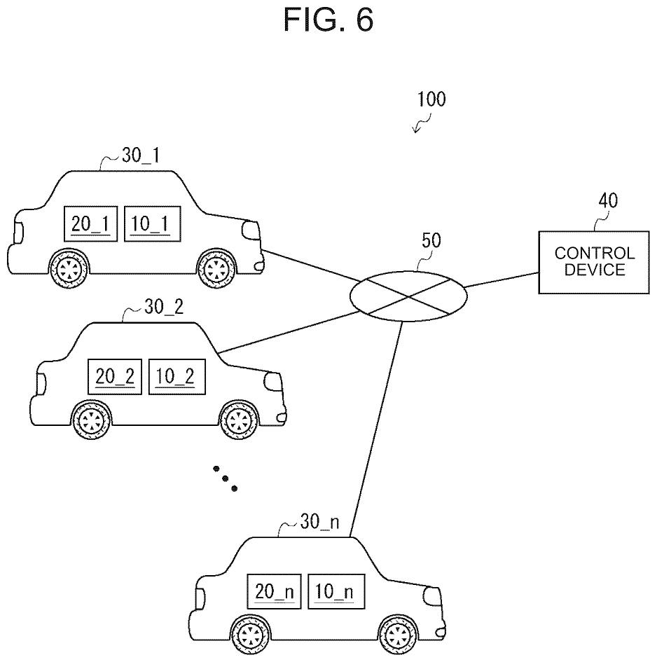

FIG. 6 is a block diagram showing an exemplary configuration of a battery management system 100 according to Embodiment 2. The battery management system 100 includes n (n is an integer of 2 or more) battery management devices 10 provided so as to correspond to n secondary batteries 20, a control device 40, and a network 50. The n battery management devices 10 and the control device 40 are configured to be capable of communicating with each other through the network 50. Hereinafter, the n secondary batteries 20 are also referred to as secondary batteries 20_1 to 20_n, and the n battery management device 10 are also referred to as battery management devices 10_1 to 10_n.

The secondary batteries 20_1 to 20_n are mounted on vehicles 30_1 to 30_n, respectively. Further, the battery management devices 10_1 to 10_n are mounted on the vehicles 30_1 to 30_n, together with the secondary batteries 20_1 to 20_n, respectively. Each of the vehicles 30_1 to 30_n is a battery electric vehicle or a hybrid vehicle that is driven by a secondary battery.

The control device 40 learns the setting content of the allowable charging power set for each of the secondary batteries 20_1 to 20_n that are managed by the battery management devices 10_1 to 10_n, and updates the setting content of the allowable charging power set for each of the secondary batteries 20_1 to 20_n, based on the learning result. In other words, the control device 40 updates the setting content of the allowable charging power set for each of the secondary batteries 20_1 to 20_n, using an after-learning model that is generated by machine learning in which the setting content of the allowable charging power is used.

For example, in the case where the allowable charging power having a lower value than expected is, after a lapse of a predetermined use period, set for a predetermined number or more of secondary batteries 20 that are managed by the predetermined number or more of battery management devices 10 of the battery management devices 10_1 to 10_n, there is a possibility that the initial value of the allowable charging power is too high. In such a case, the control device 40 performs such a control that the allowable charging power is decreased, for all of the secondary batteries 20_1 to 20_n that are managed by the battery management devices 10_1 to 10_n. Thereby, the Li deposition in each of the secondary batteries 20_1 to 20_n is restrained. The control device 40 may set the initial value of the allowable charging power that is set for the secondary battery 20 that is newly shipped, to a low value, similarly to the secondary batteries 20_1 to 20_n.

In the present disclosure, some or all of processes of the battery management device 10 can be realized by causing a central processing unit (CPU) to execute a computer program.

The above-described program includes commands (or software codes) for causing a computer to perform one or more functions described in the embodiments when the above-described program is read by the computer. The program may be stored in a non-transitory computer readable medium or tangible storage medium. As an example, which is not a limitation, the computer readable medium or the tangible storage medium includes a random-access memory (RAM), a read-only memory (ROM), a flash memory, a solid-state drive (SSD), other memory technologies, a CD-ROM, a digital versatile disc (DVD), a Blu-ray (registered trademark) disc, other optical disc storage, a magnetic cassette, a magnetic tape, a magnetic disk storage, or other magnetic storage devices. The program may be transmitted on a transitory computer readable medium or communication medium. As an example, which is not a limitation, the transitory computer readable medium or the communication medium includes electrical, optical, acoustic, or other forms of propagation signals.

The present disclosure has been described above with reference to the embodiments. The present disclosure is not limited to the above-described embodiments. For configurations and details of the present disclosure, various alterations that can be understood by a person skilled in the art can be made within the scope of the present disclosure. Moreover, each embodiment can be combined with another embodiment, when appropriate.

What is claimed is:

1. A battery management device comprising:
a high-frequency signal supply unit that supplies a high-frequency signal having 0.1 MHz or higher, to a lithium-ion secondary battery;
an impedance detection unit that detects a value of a real part of an alternating-current impedance, from the lithium-ion secondary battery to which the high-frequency signal is supplied;
a calculation unit that calculates a Li deposition amount in the lithium-ion secondary battery, from the detected value of the real part of the alternating-current impedance; and
a control unit that decreases an allowable charging power for the lithium-ion secondary battery as the calculated Li deposition amount is larger.

2. The battery management device according to claim 1, wherein the high-frequency signal supply unit supplies the high-frequency signal having such a frequency that the detected value of the real part of the alternating-current impedance, due to a skin effect, is 10 times or more of a value of a real part of an alternating-current impedance that is detected when an alternating-current signal having 1 kHz is supplied to the lithium-ion secondary battery.

3. The battery management device according to claim 1, wherein:
the impedance detection unit detects the value of the real part of the alternating-current impedance from the lithium-ion secondary battery, at a designated measurement interval;
the calculation unit calculates a change amount of Li deposition during the designated measurement interval, based on the value of the real part of the alternating-current impedance that is detected at the designated measurement interval; and
the control unit decreases the allowable charging power for the lithium-ion secondary battery as an increase amount of Li deposition during the designated measurement interval is larger.

4. The battery management device according to claim 1, wherein the control unit dissolves the deposited Li by mandatorily discharging the lithium-ion secondary battery, when the Li deposition amount in the lithium-ion secondary battery reaches a first predetermined amount, and does not decrease and maintains the allowable charging power for the lithium-ion secondary battery, when the Li deposition amount in the lithium-ion secondary battery after Li is dissolved becomes smaller than or equal to a second predetermined amount that is smaller than the first predetermined amount.

5. A battery management system comprising:
a plurality of the battery management devices according to claim 1, the battery management devices managing a plurality of the lithium-ion secondary batteries that is mounted on a plurality of vehicles respectively; and
a control device that learns a setting content of the allowable charging power set for each of the lithium-ion secondary batteries, and updates the setting content of the allowable charging power for each of the lithium-ion secondary batteries, based on a learning result.
